(19) United States
(12) Patent Application Publication
(10) Pub. No.: US 2006/0265332 A1
(43) Pub. Date: Nov. 23, 2006

(54) Method for providing document traceability

(75) Inventors: Kevin Patrick Goffinet, Lexington, KY (US); Timothy S. Seevers, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/130,869

(22) Filed: May 17, 2005

(51) Int. Cl. G06Q 99/00

(52) U.S. Cl. 705/56

(57) ABSTRACT

A method for providing document traceability includes providing a document having an integral data storage mechanism containing prior document usage information; providing current user information relating to current processing of the document; and appending the current user information to the prior document usage information in the integral data storage mechanism of the document.

### BACKGROUND OF THE INVENTION

1. Field of the Invention

The present invention relates to document handling, and, more particularly, to a method for providing document traceability.

2. Description of the Related Art

In many customer environments, security and traceability of documents are critical, and at times may be required to satisfy privacy mandates, such as for example, under the Health Insurance Portability and Accountability Act of 1996 (HIPAA). However, once a document has been printed to paper, the ability to trace the existence of duplicates becomes a security and/or privacy issue. A traditional method of protecting the authenticity of a printed document is through watermarks that identified the author of the document if a duplicate is made (e.g. a photocopy). While this may indicate whether a given document is the original, it does not give any indication of traceability; that is, it does not show which individuals were involved in creating the duplicates.

### SUMMARY OF THE INVENTION

The present invention provides a method for providing document traceability. For example, it may be desirable to trace the history of a paper document, including who performed a duplication of a document and when the document was duplicated, in any form, by an imaging apparatus, such as a multifunction printer (MFP). The duplicate of the paper document may be, for example, a copy, a fax, or a scan stored to memory.

The invention, in one exemplary embodiment, is directed to a method for providing document traceability. The method includes providing a document having an integral data storage mechanism containing prior document usage information; providing current user information relating to current processing of the document; and appending the current user information to the prior document usage information in the integral data storage mechanism of the document.

The invention, in another exemplary embodiment, is directed to a method for providing document traceability with an imaging apparatus. The method includes providing a first document having an integral data storage mechanism containing prior document usage information; providing current user information to the imaging apparatus; and appending the current user information to the prior document usage information in the integral data storage mechanism of the document.

An advantage of the present invention is that the processing of a document, such as an original, can be traced with an indication of the processing being placed on the document itself.

Another advantage is that if a first duplicated document, i.e., a document duplicated from an original, is itself being duplicated to form a second duplicated document, then new current user information associated with the present duplication process is appended to the prior document usage information on the first duplicated document, and both the prior document usage information and the new current user information is added to the second duplicated document.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic representation of an imaging system embodying the present invention.

FIG. 2 is a flowchart of a method for providing document traceability with an imaging apparatus, in accordance with an embodiment of the present invention.

FIG. 3A is a graphical depiction of a two page document having indicia printed in the form of a bar code on each page.

FIG. 3B is a graphical depiction of the two page document of FIG. 3A having additional indicia appended to the prior indicia.

FIG. 4 is a graphical depiction of a two page document having a radio frequency identification (RFID) device embedded on each page.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

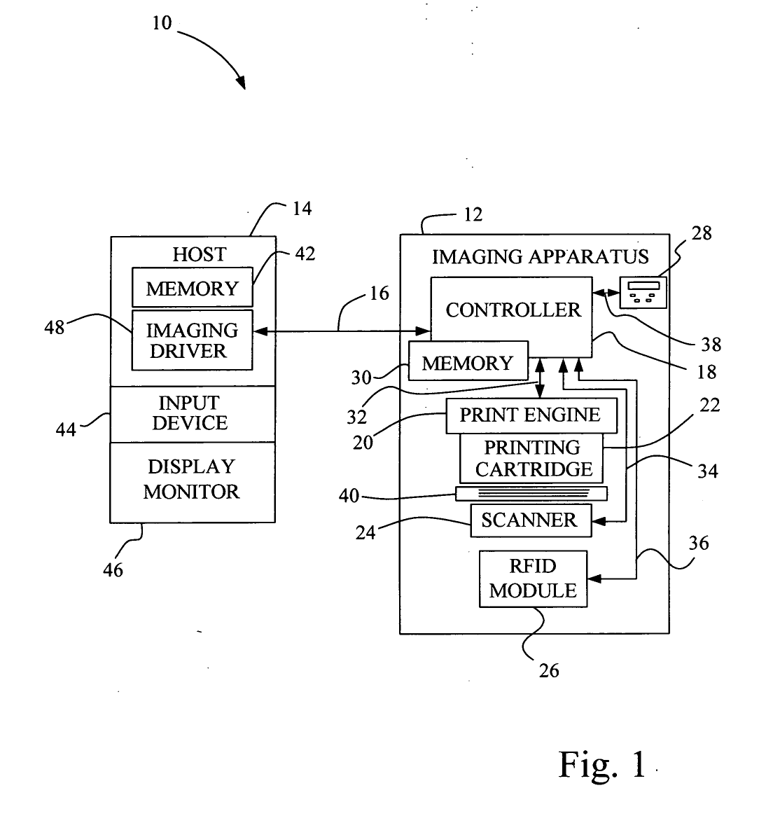

Referring now to the drawings and particularly to FIG. 1, there is shown a diagrammatic depiction of an imaging system 10 embodying the present invention. Imaging system 10 includes an imaging apparatus 12 and a host 14. Imaging apparatus 12 communicates with host 14 via a communications link 16. As used herein, the term “communications link” is used to generally refer to structure that facilitates electronic communication between two components, and may operate using wired or wireless technology.

Imaging apparatus 12 can be, for example, an ink jet printer and/or copier, an electrophotographic printer and/or copier, a thermal printer and/or copier or an all-in-one (AIO) unit that includes a print engine, a scanner, and possibly a fax unit. An AIO unit is also known in the art as a multifunction printer (MFP). For example, as shown in FIG. 1, imaging apparatus 12 includes a controller 18, a print engine 20, a printing cartridge 22, a scanner 24, an RFID module 26, and a user interface 28. Imaging apparatus 12 may communicate with host 14 via a standard communication protocol, such as for example, universal serial bus (USB) or Ethernet.

Controller 18 includes a processor unit and associated memory 30, and may be formed as one or more Application Specific Integrated Circuits (ASIC). Memory 30 may be, for example, random access memory (RAM), read only memory (ROM), and/or non-volatile RAM (NVRAM). Alternatively, memory 30 may be in the form of a separate electronic memory (e.g., RAM, ROM, and/or NVRAM), a hard drive, a CD or DVD drive, or any memory device convenient for use with controller 18. Controller 18 may be a printer controller, a scanner controller, or may be a combined printer and scanner controller. In the present embodiment, controller 18 communicates with print engine 20 via a communications link 32. Controller 18 communicates with scanner 24 via a communications link 34. Controller 18 communicates with radio frequency identification (RFID) module 26 via a communications link 36. User interface 28 is communicatively coupled to controller 18 via a communications link 38. Controller 18 serves to process print data and to operate print engine 20 during printing, as well as to operate scanner 24 and process image data obtained via scanner 24. In addition, controller 18 operates RFID module 26 during a write or read operation associated with an RFID device.

In the context of the examples for imaging apparatus 12 given above, print engine 20 can be, for example, an ink jet print engine, an electrophotographic print engine or a thermal transfer engine, configured for forming an image on a substrate 40, such as a sheet of paper, transparency or fabric. As an ink jet print engine, for example, print engine 20 operates printing cartridge 22 to eject ink droplets onto substrate 40 in order to reproduce text and/or images. As an electrophotographic print engine, for example, print engine 20 causes printing cartridge 22 to deposit toner onto substrate 40, which is then fused to substrate 40 by a fuser (not shown), in order to reproduce text and/or images.

Scanner 24, in some embodiments, may be a conventional scanner, such as for example, a sheet feed or flat bed scanner. As is known in the art, a sheet feed scanner transports a sheet to be scanned past a stationary sensor device. In a flat bed scanner, the sheet or object to be scanned is held stationary, and a scanning bar including a sensor is scanned over the stationary sheet or object. In other embodiments, scanner 24 may be, for example, a simple scanning sensor of the type typically used when aligning printheads in an ink jet print engine.

RFID module 26 is configured to read and program RFID devices which may be embedded in each page of a document. RFID module 26 may be formed using technology well known in the art, and for brevity, will not be described herein except for how it is applied in some embodiments of the present invention. In some embodiments, such an RFID device may be embedded, for example, in substrate 40. In the context of the present invention, substrate 40 may be used to form an original document generated by print engine 20, or may be used to form a copy of another document (e.g., an original or prior copy), for example, using scanner 24 (e.g., a flatbed scanner) and print engine 20. Such RFID devices may also be formed in staples or paper clips attached to a document. It is contemplated that RFID module 26 may be combined with another functional unit of imaging apparatus 12, such as for example, with scanner 24.

Host 14, which may be optional, may be, for example, a personal computer, including memory 42, such as RAM, ROM, and/or NVRAM, an input device 44, such as a keyboard, and a display monitor 46. Host 14 further includes a processor, input/output (I/O) interfaces, and at least one mass data storage device, such as a hard drive, a CD-ROM and/or a DVD unit.

Host 14 includes in its memory a software program including program instructions that function as an imaging driver 48, e.g., printer/scanner driver software, for imaging apparatus 12. Imaging driver 48 is in communication with controller 18 of imaging apparatus 12 via communications link 16. Imaging driver 48 facilitates communication between imaging apparatus 12 and host 14, and may provide formatted print data to imaging apparatus 12, and more particularly, to print engine 20, to print an image. In addition, software for operating RFID module 26 may be included in imaging driver 48.

In some circumstances, it may be desirable to operate imaging apparatus 12 in a standalone mode. In the standalone mode, imaging apparatus 12 is capable of functioning without host 14. Accordingly, all or a portion of imaging driver 48, or a similar driver, may be located in controller 18 of imaging apparatus 12 so as to accommodate printing, scanning, and/or RFID operations being handled by imaging apparatus 12 when operating in the standalone mode.

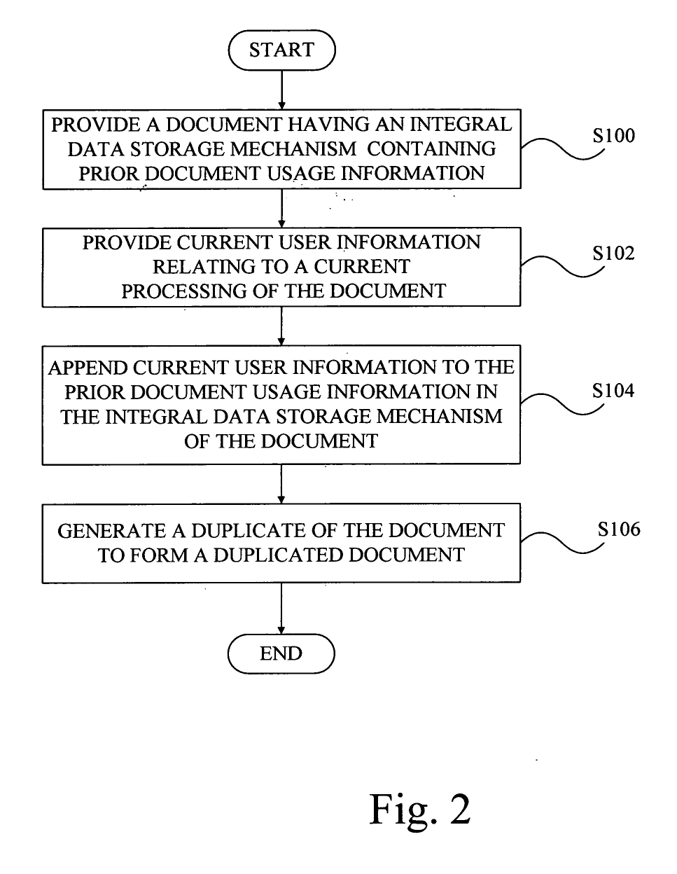

FIG. 2 is a flowchart of a method for providing document traceability with an imaging apparatus, such as imaging apparatus 12, in accordance with exemplary embodiments of the present invention. The method may be performed in conjunction with software executing, for example, in imaging driver 48, which may be located in host 14 or imaging apparatus 12.

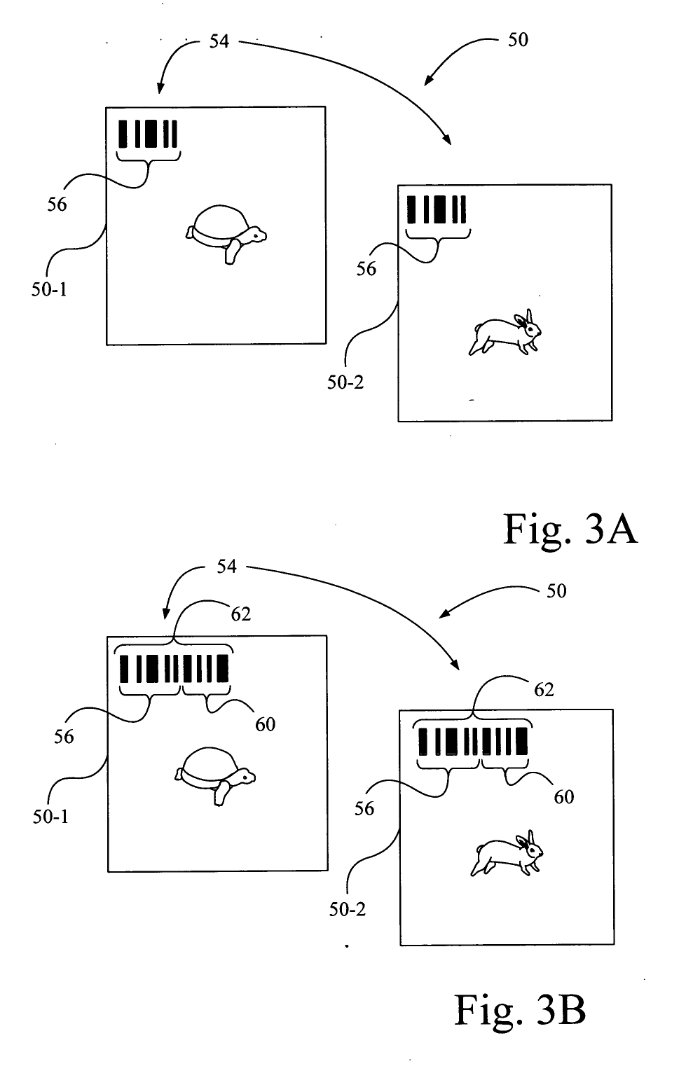

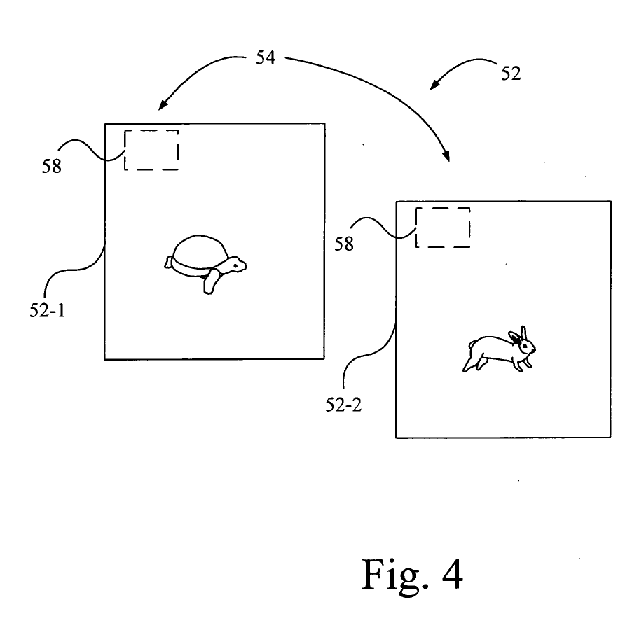

At step S100, a document, such as exemplary document 50 (see FIGS. 3A and 3B) and document 52 (see FIG. 4), is provided having an integral data storage mechanism 54 containing prior document usage information. The term “integral” means that the data storage mechanism 54 is formed on or in the substrate of the document. The document may be an original document, or may be a previously duplicated document. It is to be understood that document 50 and/or document 52 may be a single page document or have multiple pages. In the examples represented in FIGS. 3A, 3B and 4, document 50 is shown as a multi-page document having two pages, page 50-1 and page 50-2, and document 52 is shown as a multi-page document having two pages, page 52-1 and page 52-2.

The prior document usage information may include, for example, an identifier representing the document creator, the identifier of any user who has processed the document, the type or types of processing performed on the document, and the date, time and place of any such processing.

In one embodiment of the present inventions, referring to FIG. 3A, the integral data storage mechanism 54 is an indicia, such as a bar code, watermark, graphics or text, that may be printed, for example, on each page 50-1, 50-2 of document 50. In the example of FIG. 3A, the indicia is a prior indicia 56 representing a history of document 50 to date. The indicia may be located at a predetermined location on the page, such as in an upper margin of document 50.

In another embodiment of the present invention, referring to FIG. 4, the integral data storage mechanism 54 is a radio frequency identification (RFID) device 58 embedded in a substrate, such as substrate 40, of document 52. RFID device 58 may be present on each page of document 52, which may be a single page or multiple pages.

At step S102, current user information relating to a current processing of the document, e.g., document 50 or 52, is provided. The current user information may be provided, for example, to imaging apparatus 12. The current user information includes, for example, a user identifier such as the user's name, or the user's identification number.

The user information may further include information relating to the type of process being performed, such as for example, the duplicating of the document by scanning. The scanning may be, for example, a scan to memory operation, a copying operation, or a faxing operation. The user information may further include information relating to the place where the process is being performed, and the date and time when the process is occurring. If the document is copied, for example, the user information may include the number of copies of the document requested by the user, the place where the copying occurred, and the date and time when the copying occurred. If the document is faxed, for example, the user information may include the fax number of each recipient, the place where the faxing occurred, and the date and time when the faxing occurred.

At step S104, the current user information is appended to the prior document usage information in integral data storage mechanism 54 of the document.

In one embodiment, referring to FIGS. 3A and 3B, the act of appending includes printing on document 50 additional indicia 60 corresponding to the current user information to supplement the prior indicia 56 previously located on document 50. For convenience, the combination of prior indicia 56 and additional indicia 60 may be referred to as combined indicia 62. As shown in this example, the additional indicia 60 may be placed adjacent to prior indicia 56.

Alternatively, the prior indicia 56 and the additional indicia 60 may be interleaved.

As a further alternative, additional indicia 60 may be located on document 50 at a location remote from prior indicia 56, such as for example, in another margin of the printed page, or on the opposite side of the page.

The combined indicia 62 thus formed on document 50 may later be read by the user or by machine, thus providing tracking of document 50. The size of prior indicia 56 and additional indicia 60 shown in FIGS. 3A and 3B is greatly exaggerated with respect to the size of the page, and is exemplary only. The actual size of prior indicia 56 and/or additional indicia 60 may be selected, as desired. For example, the combined indicia 62 may be sized to be large enough to be human perceivable and machine perceivable, or machine perceivable only. The lower limitation on decreasing the size of prior indicia 56 and/or additional indicia 60 is that the indicia be at least machine readable, such as for example, by scanner 24.

In the RFID embodiment, the act of appending includes storing the current user information in RFID device 58 of document 52, along with the prior stored prior document usage information.

At step S106, a duplicate of the document, such as document 50 or document 52, is generated to form a duplicated document. The duplicate may be, for example, a copy, a fax, or a scan to memory.

As an extension of the method steps described above, in one embodiment, the additional indicia 60 may become part of the duplicated document created from document 50. For example, the duplicated document also includes both the prior indicia 56 and additional indicia 60, i.e., the combined indicia 62. The practical result is that if the first duplicated document, e.g., a document duplicated from document 50, is itself duplicated to form a further (second) duplicated document, a new current user information indicia associated with the present duplication process is appended to combined indicia 62 to be printed on the first duplicated document, and both combined indicia 62 and the new current user information is printed on the second duplicated document.

Similarly, in the RFID embodiment, the RFID device 58 embedded in the duplicated document that was duplicated from document 52 also stores a combination of the current user information and the prior document usage information, and if it is itself duplicated, the new current user information associated with the duplication process would be stored in RFID device 58 as well.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for tracing a document, said document having indicia that is integral to said document, said indicia including a history of prior usage of said document, comprising:
capturing user information relating to a current processing of said document; and
updating said indicia by appending at least a portion of said user information to said usage history.

2. The method of claim 1, further comprising generating a new version of said document that has said updated indicia integrated into said new version of said document.

3. The method of claim 1, wherein said indicia is printed on said document.

4. The method of claim 1, wherein said indicia is one of a bar code, watermark, graphic or text.

5. The method of claim 1, wherein said document has a plurality of pages and said indicia is a bar code that is present on each page.

6. The method of claim 2, wherein said indicia is printed on said document and the step of appending comprises printing at least a portion of said user information near said printed indicia to form said updated indicia.

7. The method of claim 2, wherein said new version of said document is a duplicate of said document.

8. The method of claim 7, wherein said updated indicia comprises a combined indicia representing said usage history and at least a portion of said user information that is printed on said duplicate.

9. The method of claim 8, wherein if said duplicate is itself duplicated by a second user to form a second duplicated document, information about said second user is printed on both said duplicate and said second duplicated document.

10. A method for of tracing a document that has an integral data storage mechanism that contains information about prior document usage, said method comprising:
capturing current user information relating to a current processing of said document; and
appending said current user information to said prior document usage information in said integral data storage mechanism of said document.

11. The method of claim 10, wherein said integral data storage mechanism comprises a radio frequency identification (RFID) device embedded in a substrate of said document.

12. The method of claim 11, wherein the step of appending comprises storing said current user information in said RFID device of said document with said prior document usage information previously stored in said RFID device.

13. The method of claim 10, further comprising storing said current user information and said prior document usage information in an RFID device embedded in at least one page of a duplicate of said document.

14. A method for using an imaging apparatus to trace a document, said document having a first indicia representative of prior usage of said document, said method comprising:
receiving, at said imaging apparatus, data associated with a user;
appending data representative of said user to said first indicia to create a second indicia;
duplicating at least a portion of said document; and
associating said second indicia with said duplicated portion.

15. The method of claim 14, updating said document to include said appended data.

16. The method of claim 14, wherein said first indicia is printed on said document, and said second indicia is printed on said duplicated portion.

17. The method of claim 14, wherein the step of duplicating said document comprises generating an electronic image representative of at least a portion of said document.
